(19) United States
(12) Patent Application Publication
(10) Pub. No.: US 2018/0260933 A1
(43) Pub. Date: Sep. 13, 2018

(54) DISPLAY APPARATUS AND CONTROL METHOD THEREOF

(71) Applicant: SAMSUNG ELECTRONICS CO., LTD., Suwon-si (KR)

(72) Inventors: Ho-yong SON, Hwaseong-si (KR); Young-chan KIM, Uiwang-si (KR)

(73) Assignee: SAMSUNG ELECTRONICS CO., LTD., Suwon-si (KR)

(21) Appl. No.: 15/915,320

(22) Filed: Mar. 8, 2018

(30) Foreign Application Priority Data
Mar. 10, 2017 (KR) 10-2017-0030846

(51) Int. Cl. G06T 3/40

(52) U.S. Cl. CPC G06T 3/40; H04L 67/12

(57) ABSTRACT

A display apparatus is provided. The display apparatus includes a communication interface; a display; and a processor configured to control the communicator to receive a content image from a server, control a screen of the display to display the content image and a first image, determine a size of the first image as displayed on the screen of the display apparatus, generate a second image by resizing the first image in response to determining the size of the first image does not correspond to a sensible size, and control the screen of the display to display the content image and the second image.

### CROSS-REFERENCE TO RELATED THE APPLICATION

This application is based on and claims priority under 35 U.S.C. § 119 to Korean Patent Application No. 10-2017-0030846, filed on Mar. 10, 2017, in the Korean Intellectual Property Office, the disclosure of which is incorporated by reference herein in its entirety.

### BACKGROUND

### Field

The disclosure relates to a display apparatus and a control method thereof, and more particularly to a display apparatus and a control method thereof which determine whether content is reproduced.

### Related Art

Digital signage refers to a display which is larger than a general display and is used for reproducing an image such as advertisement content or the like, and is also called a large format display (LFD).

The digital signage is remotely manageable through a network, and reproduces an image such as advertisement content, etc., in accordance with appointed schedules by downloading the image from a server or other external device.

In general, the digital signage provides a proof-of-play (POP) solution so that a user can know whether appointed content is reproduced for a certain period of time under environments of reproducing advertisement content.

In the POP solution, a red (R), blue (B) and green (G) (RGB) sensor senses an RGB mark displayed together with content being reproduced, which is used to determine whether the content is reproduced.

However, when content is distributed to display panels of various sizes, the RGB mark is displayed with different sizes corresponding to the panel sizes and therefore a problem arises in that the RGB sensor may not sense the RGB mark.

### SUMMARY

In accordance with an aspect of the disclosure, there is provided a display apparatus and a control method thereof, in which it is checked whether content is reproduced regardless of the size of a display panel.

In accordance with an aspect of the disclosure, there is also provided a display apparatus and a control method thereof, in which sensitivity to an image is improved to check whether content is reproduced or not.

According to embodiments of the disclosure, there is provided a display apparatus including a communication interface; a display; and a processor configured to control the communication interface to receive a content image from a server, control a screen of the display to display the content image and a first image, determine a size of the first image as displayed on the screen of the display apparatus, generate a second image by resizing the first image in response to determining the size of the first image does not correspond to a sensible size, and control the screen of the display to display the content image and the second image.

The content image received from the server may include the first image.

The processor may be further configured to control the communication interface to individually receive the content image and the first image from the server.

The processor may be further configured to generate the second image by downscaling the first image to the sensible size in response to the size of the first image being larger than the sensible size.

The processor may be further configured to perform an image process to cease display of the first image in response to determining the size of the first image does not correspond to the sensible size.

The display apparatus may further include a sensor configured to monitor a sensing area of the screen, and the processor may be further configured to provide a user interface (UI) for guiding adjustment of the sensing area based on the first image not corresponding to the sensing area.

The display apparatus may further include a sensor configured to monitor a sensing area of the screen and a storage configured to store a plurality of images respectively corresponding to a plurality of content images, and the processor may be further configured to determine whether a corresponding content image of the plurality of content images is normally reproduced based on whether the sensor sensing a corresponding one of the plurality of images in the sensing area.

The display apparatus may further include a sensor configured to monitor a sensing area of the screen, and the processor may be further configured to perform optical character recognition (OCR) data generated by the sensor and control the communication interface to transmit a result of the OCR to the server.

The first image may include a specific color pattern for identifying the content image.

According to other aspects of the disclosure, there is provided a method of controlling a display apparatus, the method including: receiving a content image from a server; displaying the content image on a screen of the display apparatus; determining a size of a first image as displayed on the screen; and displaying a second image generated by resizing the first image in response to determining the size of the first image does not correspond to a sensible size.

The content image received from the server may include the first image.

The method may further include receiving the first image from the server separate from the content image.

The resizing the first image may include downscaling the first image to the sensible size in response to the size of the first image being larger than the sensible size.

The method may further include ceasing display of the first image in response to determining the size of the first image does not correspond to the sensible size.

The method may further include: sensing a sensing area of the screen, and providing a user interface (UI) for guiding adjustment of the sensing area based on the first image not corresponding to the sensing area.

The method may further include: storing a plurality of images respectively corresponding to a plurality of content images, sensing the second image by a sensor, and determining whether the content image is normally reproduced based on whether the sensed second image corresponds to one of the plurality of images.

The method may further include: sensing the second image displayed on the screen by a sensor; receiving the sensed second image; performing optical character recognition (OCR) on the received second image; and transmitting a result of the OCR to the server.

The first image may include a specific color pattern for identifying the content image.

According to still other embodiments of the disclosure, there is provided a non-transitory computer readable recording medium having embodied thereon a program, which when executed by a processor of a display apparatus causes the display apparatus to execute a method, the method including: receiving a content image from a server; displaying the content image on a screen of the display apparatus; determining a size of a first image as displayed on the screen; and displaying a second image generated by resizing the first image in response to determining the size of the first image does not correspond to a sensible size.

### BRIEF DESCRIPTION OF THE DRAWINGS

The above and other aspects, features and advantages of certain embodiments of the disclosure will be more apparent from the following description taken in conjunction with the accompanying drawings, in which:

FIG. 1 is a schematic view of showing a flow of operations between a display apparatus and external devices according to an embodiment;

FIG. 2 is a block diagram of a display apparatus according to an embodiment;

FIG. 3 shows an example of determining whether a content image is reproduced when the content image encoded with an image is distributed according to an embodiment;

FIG. 4 shows an example of determining whether a content image is reproduced when the content image and the image are individually distributed according to an embodiment;

FIG. 5 shows an example of an image displayed with the same size as a sensing area in a display of a general size according to an embodiment;

FIG. 6 shows an example of an image displayed with a larger size than a sensing area in a large display according to an embodiment;

FIG. 7 shows an example of downscaling an image displayed with a larger size than a sensing area according to an embodiment;

FIG. 8 shows an example of upscaling an image displayed with a smaller size than a sensing area according to an embodiment;

FIG. 9 shows an example of an image processing method based on downscaling of an image according to an embodiment;

FIG. 10 shows an example of a detailed image conversion process according to an embodiment;

FIG. 11 shows an example of a user interface (UI) provided to a user when an image is not sensed in a sensing area according to an embodiment; and

FIG. 12 is a flowchart of a control method of a display apparatus according to an embodiment.

### DETAILED DESCRIPTION

Hereinafter, embodiments will be described in detail with reference to accompanying drawings so as to be easily materialized by a person having ordinary knowledge in the art to which the embodiments pertain. The disclosure may be achieved in various forms and not limited to the following embodiments.

As used herein, the terms “1st” of “first” and “2nd” or “second” may use corresponding components regardless of importance or order and are used to distinguish a component from another component without limiting the components. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

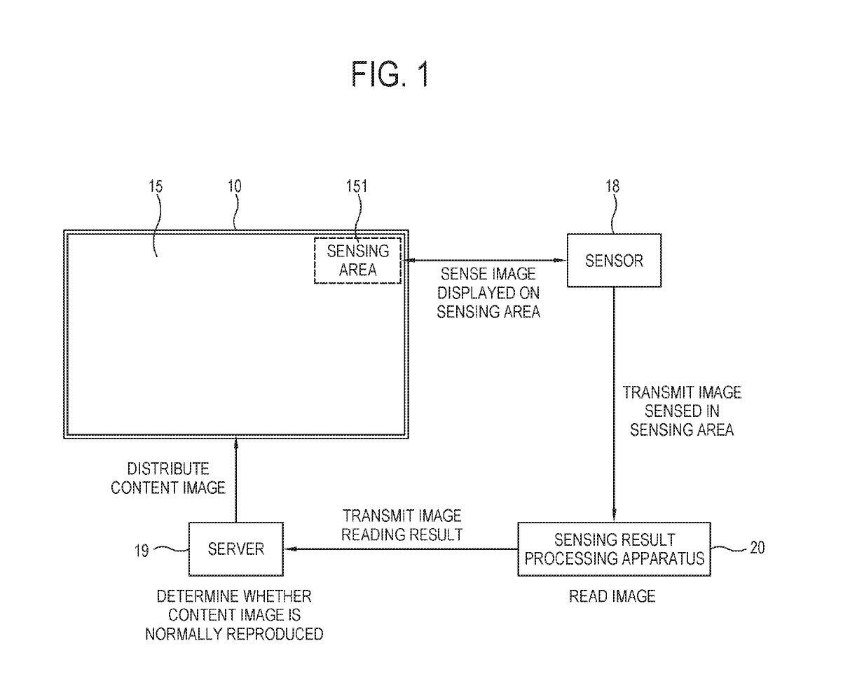

Below, features and embodiments will be first described with reference to FIG. 1 to FIG. 4. FIG. 1 is a schematic view of showing a flow of operations between a display apparatus 10 and external devices according to an embodiment. As shown in FIG. 1, the display apparatus 10 receives a content image distributed from a server 19 and reproduces it on a display 15. For example, the display apparatus 10 may be a large format display (LFD), and reproduces the content image distributed from the server 19 in accordance with previously appointed schedules.

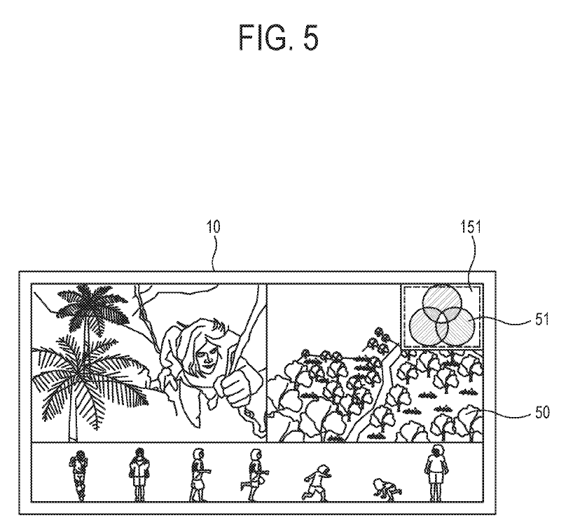

In this case, as shown in FIG. 5, the server 19 sends the display apparatus 10 an identification image 51 for checking whether a content image 50 has been reproduced. The identification image 51 may be materialized in the form of arranging a specific color pattern for identifying the content image 50, and may for example include an RGB mark formed by combination of red (R), green (G) and blue (B) colors.

Further, the server 19 may transmit position information, size information, etc., about the identification image 51 to the display apparatus 10. In this case, the position information refers to information about a display position of the identification image 51 set corresponding to the position of a sensor 18 connected to the display 15, and thus the identification image 51 is displayed on the display 15 based on the position information.

The size information refers to information about the size of the identification image 51, and thus the display apparatus 10 determines whether the identification image 51 is sensible by the sensor 18 based on the size information.

Alternatively, where the server 19 provides no size information about the identification image 51, the display apparatus 10 may directly determine the size of the identification image 51 and then determine whether the identification image 51 is sensible by the sensor 18.

When the size of the identification image 51 received from the server 19 is not sensible by the sensor 18, the display apparatus 10 converts the size of the identification image 51 into a sensible size. In this case, both the sensible size of the sensor 18 and the screen size of the display 15 are taken into account for downscaling or upscaling the identification image 51.

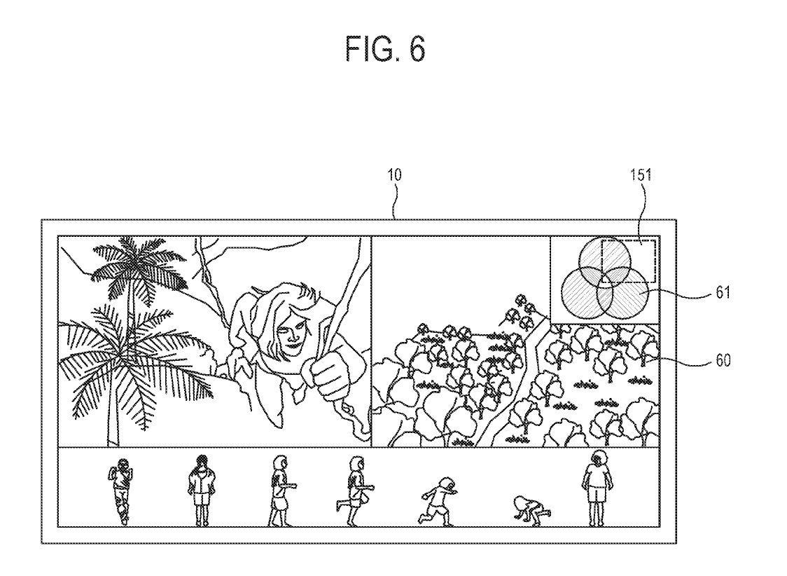

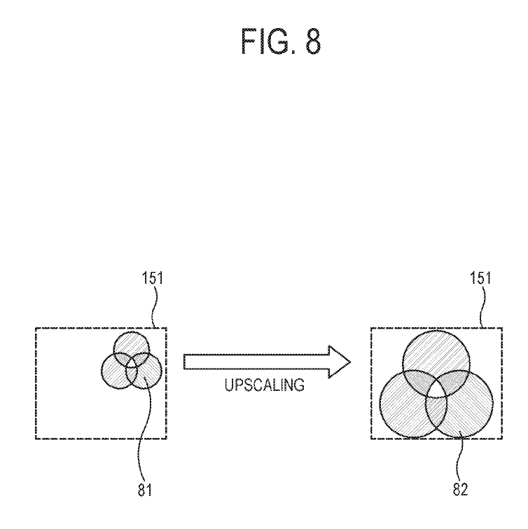

Referring to an example shown in FIG. 6, when an identification image 61 provided from the server 19 is produced based on the size of a display having a first size, the identification image 61 is enlarged and displayed on the display 15 in case that the display apparatus 10 has a second size larger than the first size, and therefore the identification image 61 is subject to downscaling to be sensed by the sensor 18. When the display apparatus 10 is a small display as shown in FIG. 8, an identification image 81 is downsized and displayed on the display 15, and therefore the identification image 81 is subject to upscaling to be sensed by the sensor 18.

For example, when the sensor 18 has a sensible size having a horizontal size of 1 cm and a vertical size of 1 cm, and the display apparatus has a screen size having a horizontal size of 160 cm and a vertical size of 90 cm and supports full high definition (FHD), the size of the identification image 51 is converted by the following calculation method. In this case, the sensible size of the sensor 18 may be received in the display apparatus 10 as basic information from the sensor 18 and automatically set when the sensor 18 is connected to the display apparatus 10, or may be directly input by a user.

Horizontal size Horizontal sensing range horizontal pixels:X pixels

160:1=1920:X

X=12

Vertical size:Vertical sensing range=vertical pixels:Y pixels

90:1=1080:Y

Y=12

By the foregoing method, the size of the identification image 51 is determined as 12*12 pixels, and the identification image 51 received from the server 19 is converted to have the determined size so as to be sensed by the sensor 18.

The sensor 18 may be separately provided outside the display apparatus 10, and for example attached in proximity of a sensing area 151. The sensor 18 senses the identification image 51 displayed on the sensing area 151. In this case, the sensor 18 senses the identification image 51, the size of which is converted into a sensible size by upscaling or downscaling.

The sensor 18 may be for example materialized by the RGB sensor capable of sensing RGB colors. The RGB sensor takes the identification image 51 through a charged coupled display (CCD) lens, and uses three kinds of filters for sensing red, green and blue colors, thereby outputting results of sensing the colors of the identification image 51.

The sensor 18 transmits the identification image 51 sensed by the sensing area 151 to a sensing result processing apparatus 20. The sensing result processing apparatus 20 may be for example a personal computer (PC), a tablet computer, a smart phone, etc. For example, the RGB sensor transmits results of sensing the colors of the identification image 51 displayed on the sensing area 151 to the sensing result processing apparatus 20, and the sensing result processing apparatus 20 reads and transmits the sensing results to the server 19. The server 19 determines whether the content is normally reproduced, based on the results of reading the identification image 51 received from the sensing result processing apparatus 20.

According to one embodiment, the sensor 18 may be materialized by software such as an application or the like. In this case, the software may crop the identification image displayed on the sensing area 151, and perform optical character recognition (OCR) with regard to the cropped identification image 51.

Alternatively, the sensor 18 may be materialized by hardware or software provided in a separate device, e.g., a smart phone. In this case, the smart phone is connected to the display apparatus 10 by Wi-Fi direct or the like wireless communication method, crops the identification image 51 displayed on the sensing area 151, and applies the OCR to the cropped identification image 51.

As described above, the display apparatus 10 according to one embodiment has an improved sensitivity to the identification image for checking whether the content is reproduced. Further, it is possible to check whether the content is reproduced, regardless of the size of the display panel.

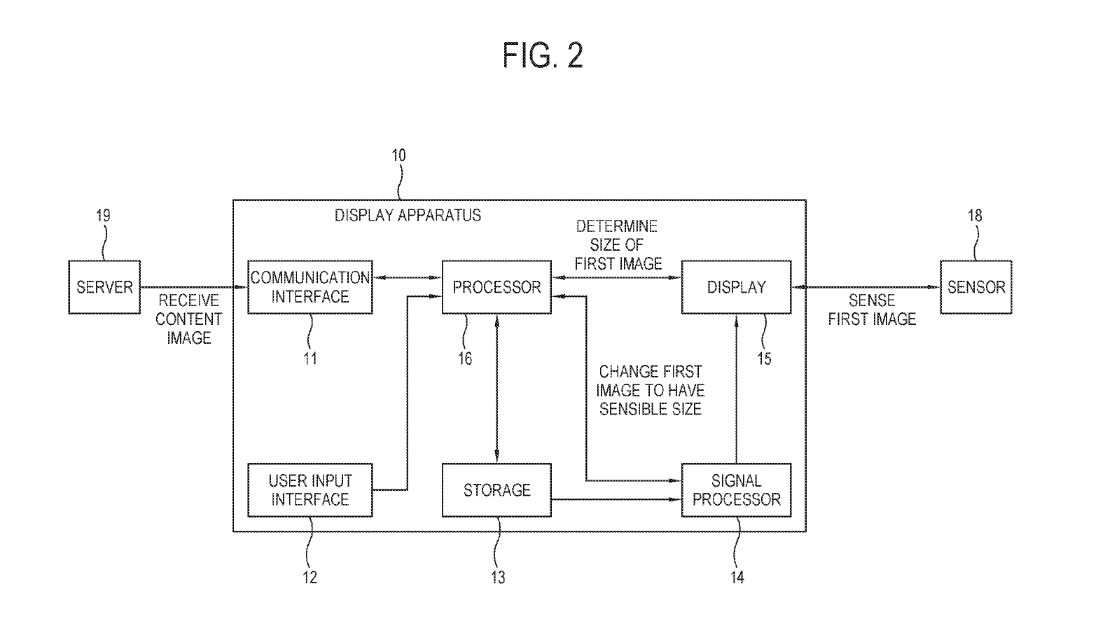

FIG. 2 is a block diagram of a display apparatus according to an embodiment. As shown in FIG. 2, a display apparatus 10 according to this embodiment includes a communication interface 11, a user input interface 12, a storage 13, a signal processor 14, a display 15 and a processor 16, and communicates with a server 19 through the communication interface 11. The communication interface 11 may be a transceiver (transmitter and receiver). The display apparatus 10 may be for example materialized by a large format display (LFD) configured to be used as an electronic display board for advertising, a display for exhibition, and the like; digital signage configured to reproduce content of various formats based on schedules; etc. The display apparatus 10 according to an embodiment is not limited to such an LFD device, a digital signage product, etc., but may be applied to various display apparatuses

By the way, the sensor 18 may be connected to the sensing result processing apparatus 20, and the sensor 18 may transmit the identification image sensed in the sensing area 151 of the display 15 to the sensing result processing apparatus 20. The sensing result processing apparatus 20 may be for example a computer, a mobile phone, a tablet computer, etc.

The elements of the display apparatus 10 are not limited to the foregoing descriptions, and may exclude some elements or include some additional elements.

Referring to the shown block diagram, the elements will be described below in detail.

The communication interface 11 is configured to communicate with the server 19 storing a plurality of content images through a wired or wireless communication method. To communicate with the server 19, the communication interface 11 may use the wired communication method such as Ethernet, etc., or the wireless communication method such as Wi-Fi, Bluetooth, etc., through a wireless router. For example, the communication interface 11 may be a printed circuit board (PCB) including a wireless communication module for Wi-Fi. However, there are no limits to the communication methods of the communication interface 11. Alternatively, the communication interface 11 may communicate with the server 19 through another communication method.

The user input interface 12 is configured to receive a user's input for controlling at least one function of the display apparatus 10. For example, the user input interface 12 may receive a user's input for selecting a part of a user interface displayed on the display 15. The user input interface 12 may be an input panel provided outside the display apparatus 10 or a remote controller using an infrared ray to communicate with the display apparatus 10. Further, the user input interface 12 may be a keyboard, a mouse or the like connected to the display apparatus 10, or may be a touch screen provided in the display apparatus 10.

The storage 13 is configured to store a plurality of content images downloaded from the server 19 through the communication interface 11. The storage 13 makes each piece of data of the plurality of stored content images be subject to reading, writing, editing, deleting, updating, etc. The storage 13 may be flash memory, a hard disc drive or the like nonvolatile memory that retains data regardless of whether the display apparatus 10 is turned on or off.

The signal processor 14 is configured to perform a preset video processing process to reproduce the plurality of content images stored in the storage 13. The signal processor 14 includes a demuxer, a decoder and a renderer, and each of such elements corresponds to a part of the video processing processes. Besides, the video processing processes performed in the signal processor 14 may further include de-interlacing, scaling, noise reduction, detail enhancement, etc., without limitations. The signal processor 14 may be a system on chip (SoC) where many functions are integrated, or an image processing board to which individual modules for independently performing the processes are mounted.

The display 15 reproduces and displays a content image based on a video signal processed by the signal processor 14. The display 15 is provided as a large format display (LFD) that displays a guide screen to be used in a public place, a commercially used advertising screen, etc. The LFD may be also called a digital signage or a digital information display. The display 15 may be achieved by various types. For example, the display 15 may be achieved by a plasma display panel (PDP), a liquid crystal display (LCD), an organic light emitting diode (OLED), a flexible display, etc., without limitations.

The sensing area 151 corresponds to an area, in which the sensor 18 is placed, of the entire screen area of the display 15, and has a sensible size determined based on the performance, arranged position, etc., of the sensor 18. In this case, the size of the sensing area 151 may be adjusted by a user as desired within a limitation based on the performance of the sensor 18.

The display 15 displays a content image received from the server 19, and displays a first image on a part of the screen as the identification image for checking whether the content image is reproduced. In this case, the first image, which is displayed on the sensing area 151 of the screen corresponding to a position where the sensor 18 is arranged, is sensed when the sensor 18 is normally operating.

The sensor 18 is separately provided outside the display apparatus 10. The sensor 18 senses the first image displayed on the sensing area 151, and may be, for example, materialized by the RGB sensor capable of sensing the RGB colors included in the first image.

The processor 16 is materialized by at least one processor for controlling a program command to be executed so that all the elements involved in the display apparatus 10 can operate. The at least one processor may be a central processing unit (CPU), and includes three regions for control, a computation and a register. The control region analyzes a program command, and controls the elements of the display apparatus 10 to operate in accordance with the analyzed commands. The computation region performs arithmetic operations and logical operations, and implements computations needed for operating the elements of the display apparatus 10 in response to a command from the control region. The register region is a memory location to store information or the like needed while the CPU is executing an instruction, stores instructions and data for the elements of the display apparatus 10 and computation results.

The processor 16 receives the content image from the server 19 and displays it on the screen of the display 15. In this case, the processor 16 may receive the content image including the first image from the server 19. Alternatively, the processor 16 may receive data of the content image and data of the first image from the server 19.

The first image may be prepared corresponding to one content image distributed from the server 19. Alternatively, the first image may be provided corresponding to a content group including a plurality of content images, which are distributed from the server 19 and set to be reproduced in accordance with the appointed schedules.

The processor 16 determines the size of the first image sensed by the sensor 18 as displayed in the content image. In this case, the sensor 18 senses the first image displayed on the sensing area 151 within the area of the display 15.

The example of FIG. 5 shows a case that the first image 51 produced with a size suitable for the display of a general size is distributed from the server 19 and the display apparatus 10 has the display 15 of the general size.

In this case, the first image 51 displayed on the sensing area 151 is displayed with the same size as the sensing area 151. Therefore, the sensor 18 is capable of sensing the first image 51 displayed on the sensing area 151.

The processor 16 converts the first image into a sensible size when it is determined that the size of the first image is not matched with the size sensible by the sensor 18. According to one embodiment, the processor 16 generates a second image by downscaling the first image into a sensible size when the first image is larger than the sensible size. Further, the processor 16 generates a second image by upscaling the first image into a sensible size when the first image is smaller than the sensible size. In this case, the processor 16 changes the size of the first image to generate the second image by taking the screen size of the display 15 into account.

The processor 16 processes the second image, which is generated by changing the size of the first image as described above, to be displayed on the screen where the content image is displayed. In this case, the second image is displayed in the form of on screen display (OSD) as overlaying the content image.

For example, the example of FIG. 6 shows a case that a first image 61 produced with a size suitable for the display of a general size is distributed from the server 19, and the display apparatus 10 has a display 15 of a large size, for example, having a resolution of FHD or UHD.

In this case, the first image 61 is enlarged in proportion to the screen size of the display 15, and thus displayed with the size larger than the sensing area 151. Therefore, the sensor 18 does not sense the first image 61 displayed with the size larger than the sensing area 151.

In this case, the processor 16 changes the first image 61 to have the same size as that of the sensing area 151 in order to prevent the foregoing error that the sensor 18 does not sense the first image 61.

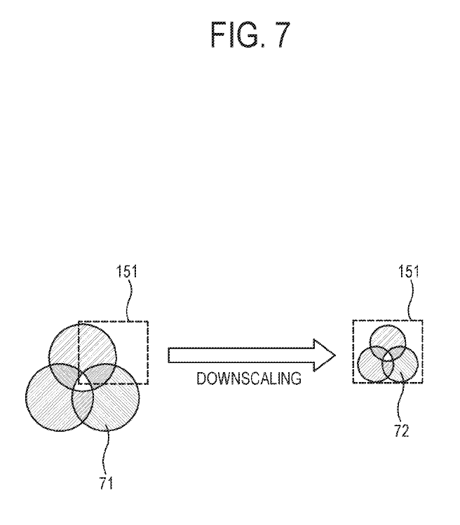

FIG. 7 shows an example of downscaling an image displayed with a larger size than a sensing area according to an embodiment. As shown in FIG. 7, when a first image 71 corresponding to the content image is displayed with a larger size than the sensing area 151, there is an error that the sensor 18 does not sense the first image 71.

To prevent such an error, the processor 16 generates a second image 72 by changing the first image 71 to have the same size as the sensing area 151. That is, the processor 16 performs downscaling the first image 71 to have the same size as the sensing area 151, thereby generating the second image 72 sensible by the sensor 18.

FIG. 8 shows an example of upscaling an image displayed with a smaller size than a sensing area according to an embodiment. As shown in FIG. 8, when a first image 81 corresponding to the content image is displayed with a smaller size than the sensing area 151, the sensor 18 senses the first image 81 in only a part of the sensing area 151.

That is, the sensor 18 senses the first image 81 displayed on the part of the sensing area 151, but may meet with a distorted result when the sensed first image 81 is read by comparison with an original image because the first image 81 is smaller than the sensing area 151.

To prevent such a distortion, the processor 16 generates a second image 82 by changing the first image 81 to have the same size as the sensing area 151. That is, the processor 16 performs upscaling the first image 81 to have the same size as the sensing area 151, thereby generating the second image 82 sensible by the sensor 18.

According to one embodiment, the processor 16 may perform an image process to erase an area of the first image, which excludes the second image from the whole area of the first image, not to be visibly recognized. For example, the downscaled second image is displayed in the form of overlaying a smaller area than the first image, and therefore the first image is partially visible to a user. In this case, a remaining area of the first image except an area where the downsized second image is displayed is subject to one among a black image process, a blurring image process, and an extension image process, so that a user cannot recognize a part of the first image.

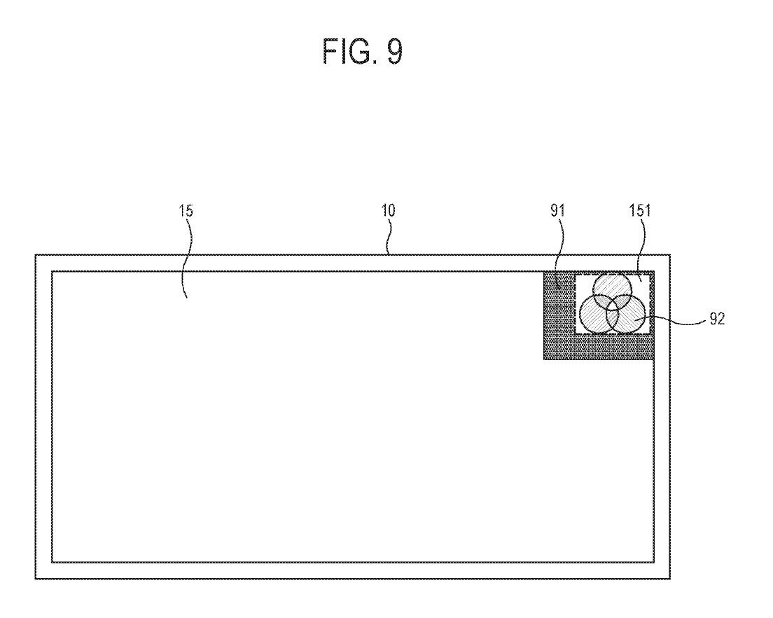

As shown in FIG. 9, when first image (not shown) corresponding to a content image is displayed with a larger size than the sensing area 151, the processor 16 performs downscaling the first image to have the same size as the sensing area 151, thereby generating a second image 92 sensible by the sensor 18.

In this case, the downscaled second image 92 is displayed in the form of overlaying the sensing area 151 smaller than the first image, and therefore the first image is partially visible to a user.

Therefore, the processor 16 may perform an image process to erase a remaining area 91 of the first image except an area where the downscaled second image 92 is displayed. That is, the processor 16 processes the remaining area 91 by one of the black image process, the blurring image process, and the extension image process, thereby preventing the first image from being partially recognized by a user.

According to one embodiment, the processor 16 may provide a user interface (UI) for guiding a user to adjust the sensing area 151 when the sensor 18 senses no first image within the sensing area 151. For example, when the first image provided by the server 19 is displayed at a position not sensible by the sensor 18, the processor 16 may provide an interface for guiding a user to adjust the position of the sensor 18.

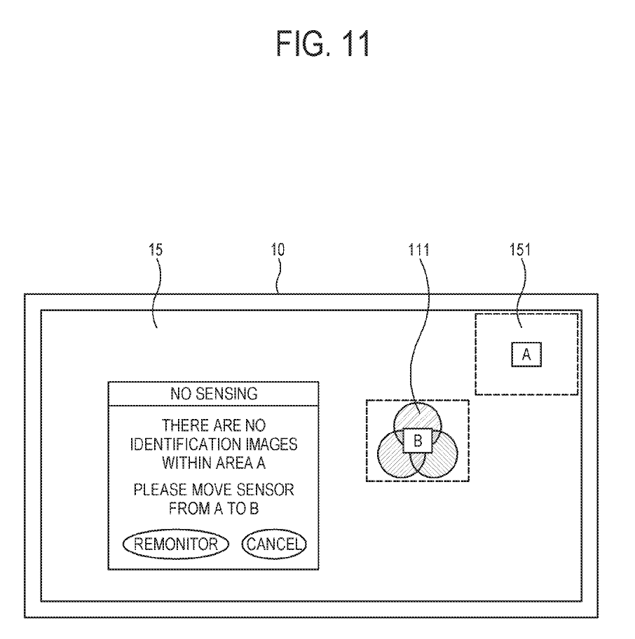

As shown in FIG. 11, when a first image 111 is not sensed by the sensor 18 within the sensing area 151, the processor 16 processes a UI 115 to be displayed for informing that an image corresponding to a content image is not sensed within an area ‘A’, thereby guiding the sensor 18 to move from the area ‘A’ to an area ‘B’.

Alternatively, when a first image 111 is displayed at a position not sensible by the sensor 18, the processor 16 processes the display position of the first image 111 to be changed to a predetermined position on the display 15 and determines whether the first image 111 displayed at the changed position is sensible by the sensor 18.

Further, when the first image 111 is still not sensible despite a single position change, it may be tested whether the first image 111 is sensed by changing its position a predetermined number or more times. In this case, the server 19 may continue to provide the first image 111 for the test until the first image 111 is sensed. With these processes, when the first image 111 is sensed, a sensing success result may be provided as a UI.

According to one embodiment, the storage 13 may be configured to store a plurality of images respectively corresponding to a plurality of content images. The plurality of content images received from the server 19 is stored and then set to be reproduced in accordance with the appointed schedules, and then the stored image is displayed together with the content image on the display 15 so as to check whether each of the content image is reproduced.

In this case, the processor 16 makes the sensor 18 sense the size-changed second image, and determines whether the content image is normally reproduced, based on whether the sensed second image is stored in the storage 13. That is, when the sensed second image is matched with the image of the content image stored in the storage 13, it is determined that the content image is normally being reproduced. When the sensed second image is not matched with the image of the content image, it is determined that the content image is not being reproduced.

According to one embodiment, the sensor 18 takes an image of the second image displayed on the screen, and the processor 16 receives the second image taken by the sensor 18 and applies OCR to the received second image. In this case, the processor 16 transmits a result of performing the OCR to the server 19, so that the server 19 can determine whether the content image is normally reproduced.

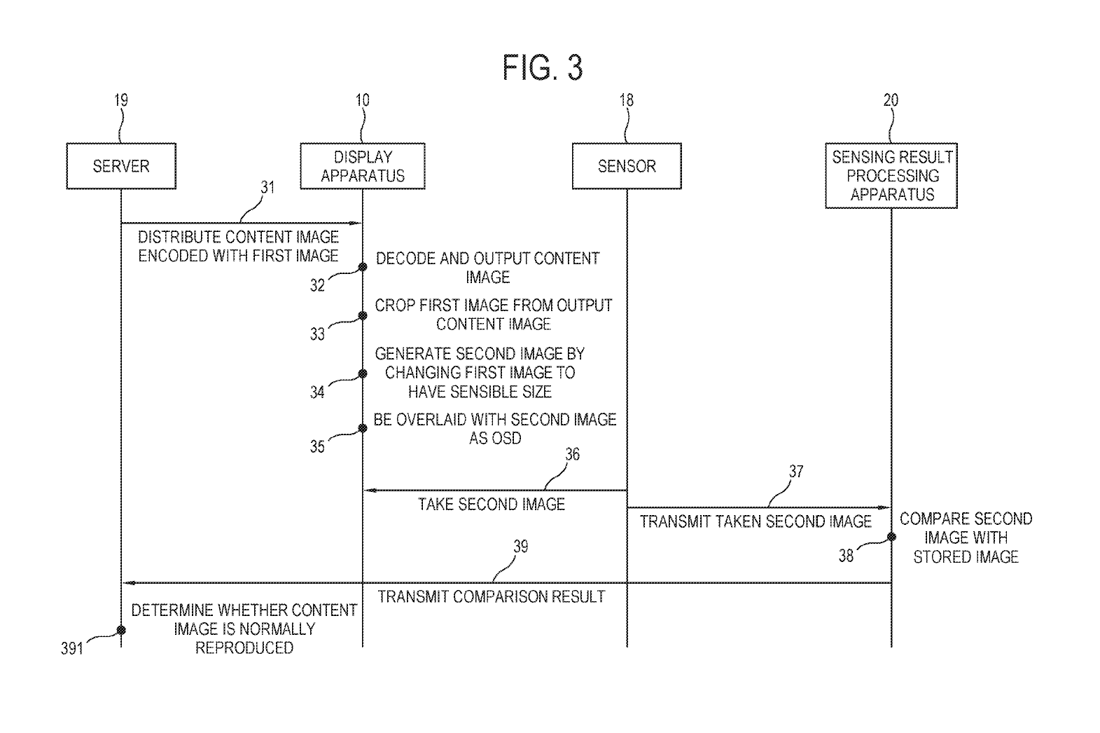

FIG. 3 shows an example of determining whether a content image is reproduced when the content image encoded with an image is distributed according to an embodiment. As shown in FIG. 3, the server 19 distributes the content image encoded with the first image to the display apparatus 10 (31), and the display apparatus 10 decodes the content image received from the server 19 and outputs it to the screen (32).

In this case, the display apparatus 10 crops the first image from the output content image (33), and generates the second image by changing the first image to have the size sensible by the sensor 18 (34). The display apparatus 10 displays the generated second image as the OSD in the form of an overlay in the state that the content image including the first image is displayed on the screen (35).

The sensor 18 takes the displayed second image 36 (36), and transmits the taken second image to the sensing result processing apparatus 20 (37). The sensing result processing apparatus 20 determines whether the second image received from the sensor 18 is matched with the stored image by comparison (38), and transmits the comparison result to the server 19 (39). In this case, the sensing result processing apparatus 20 may transmit the comparison result to not the server 19 for distributing the content image but another server for determining whether the content image is reproduced.

The server 19 determines whether the content image is normally reproduced, based on the result of comparison between the second image received from the sensing result processing apparatus 20 and the stored image (391).

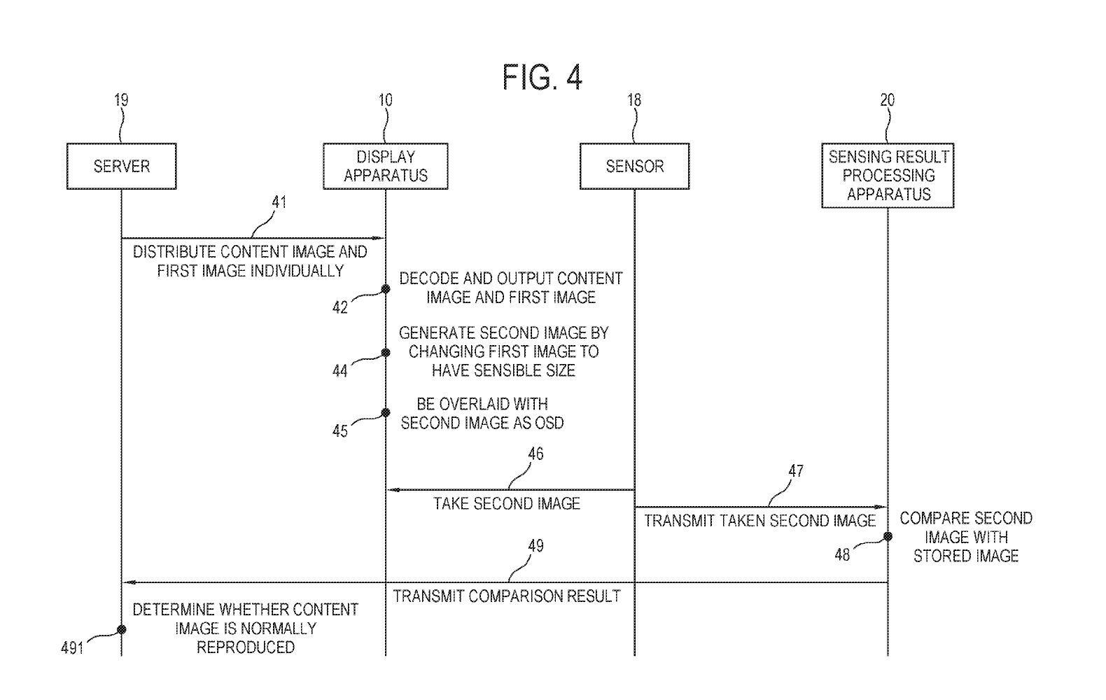

FIG. 4 shows an example of determining whether a content image is reproduced when the content image and the image are individually distributed according to an embodiment. As shown in FIG. 4, the server 19 provides the content image and the first image to the display apparatus 10 (41), and the display apparatus 10 decodes the content image and the first image received from the server 19 and outputs them on the screen (42).

In this case, the display apparatus 10 generates the second image by changing the output first image to have the sensible size for the sensor 18 (44). The display apparatus 10 displays the content image on the screen as being overlaid with the generated second image in the form of the OSD (45).

The sensor 18 takes the displayed second image 36 (46), and transmits the taken second image to the sensing result processing apparatus 20 (47). The sensing result processing apparatus 20 determines whether the second image received from the sensor 18 is matched with the stored image by comparison (48), and transmits a comparison result to the server 19 (49).

The server 19 determines whether the content image is normally reproduced, based on the comparison result received from the sensing result processing apparatus 20 (491).

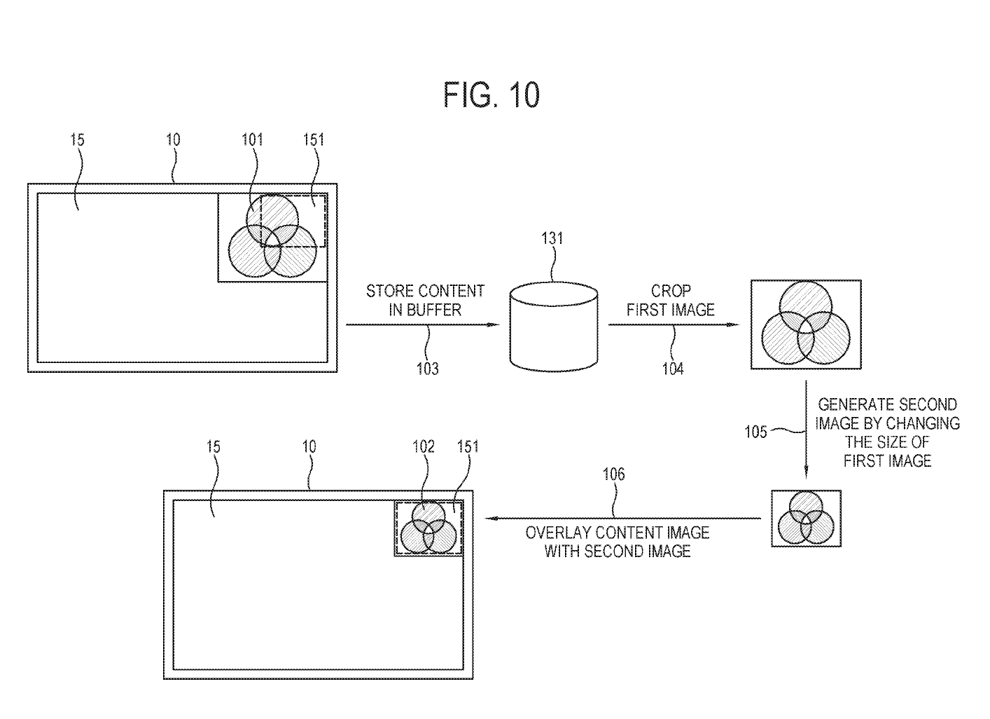

FIG. 10 shows an example of a detailed image conversion process according to an embodiment. As shown in FIG. 10, the display apparatus 10 receives a content image encoded with a first image 101 from the server 19 (31), and decodes and outputs the received content image to the screen of the display 15.

In this case, the display apparatus 10 stores the content image in a buffer 131 (103), and crops the first image 101 from the output content image (104). Next, the cropped first image 101 is changed to have the same size as the sensing area 151, thereby generating a second image 102 (105).

Last, the content image displayed on the display 15 is overlaid with the second image 102 in the form of OSD (106).

According to one embodiments, when the identification image for checking whether the content image is reproduced is enlarged corresponding to the size of the display, it may be downscaled to be sensible by the sensor 18, thereby preventing a sensing error.

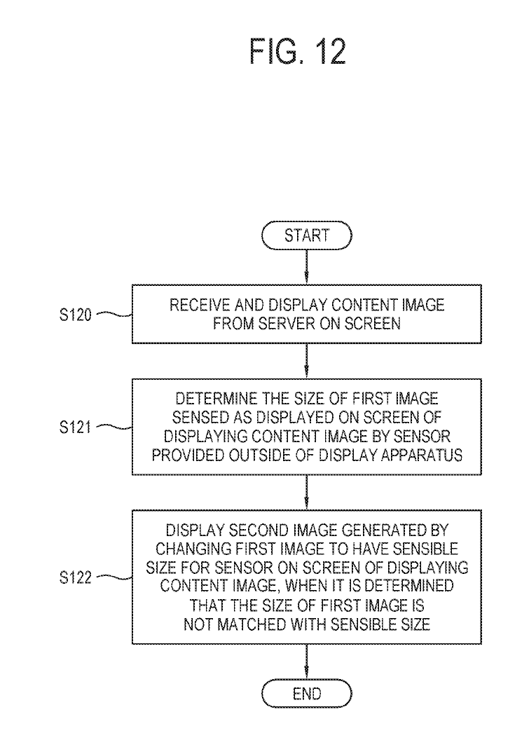

FIG. 12 is a flowchart of a control method of a display apparatus according to an embodiment. As shown in FIG. 12, at operation S120, a content image is received from the server 19 and displayed on a screen. According to one embodiment, the operation S120 may include receiving the content image with the first image from the server 19. Alternatively, the operation may include receiving data of the content image and data of the first image individually from the server 19.

Here, the first image includes an image, in which specific color patterns are arranged for identifying the content image. The first image may be provided corresponding to one content image distributed from the server 19. Alternatively, the first image may be provided corresponding to a content group including a plurality of content images distributed from the server 19 and set to be reproduced in accordance with appointed schedules.

Next, at operation S121, the size of the first image, which is sensed as displayed on the screen of displaying the content image by the sensor 18 provided outside the display apparatus, is determined. Here, the operation S121 includes controlling the sensor 18 to sense the first image displayed on the sensing area 151 within the area of the display 15.

Last, at operation S122, when it is determined that the size of the first image is not matched with the sensible size for the sensor, the second image generated by changing the first image to have the sensible size is displayed on the screen of displaying the content image.

Here, the operation S122 includes generating the second image by downscaling the first image to have the sensible size when the size of the first image is larger than the sensible size. Further, the operation 122 includes generating the second image by upscaling the first image to have the sensible size when the size of the first image is smaller than the sensible size.

In addition, the operation S122 includes displaying the second image to overlay the content image in an OSD area while the content image is displayed on the screen.

According to one embodiment, there may be added an operation of performing the image process to erase an area of the first image, which excludes the second image from the first image. Here, the image process for the erasure may include one of the black image process, the blurring image process, and the extension image process.

According to one embodiment, there may be added an operation of providing a UI for guiding a user to adjust the sensing area 151 when the sensor 18 senses no first image within the sensing area 151 of the screen.

According to one embodiment, there may be added an operation of storing a plurality of images respectively corresponding to a plurality of content images, an operation of controlling the sensor 18 to sense the second image, and an operation of determining whether the content image is normally reproduced in accordance with whether the sensed second image is stored.

According to one embodiment, there may be added an operation of receiving the second image taken by the sensor 18, applying OCR to the received second image, and transmitting an OCR result to the server 19.

According to one embodiment, the display apparatus 10 determines whether the content is reproduced, regardless of the size of the display panel. Further, it is possible to improve sensitivity to the image for checking whether content is reproduced.

As described above, one or more embodiments have an effect on checking whether content is reproduced, regardless of the size of a display panel.

Further, one or more embodiments have an effect on improving sensitivity to the image for checking whether content is reproduced.

Although a few embodiments have been shown and described, it will be appreciated by those skilled in the art that changes may be made in these embodiments without departing from the principles and spirit of the disclosure, the scope of which is defined in the appended claims and their equivalents.

What is claimed is:

1. A display apparatus comprising:
a communication interface;
a display; and
a processor configured to:
control the communication interface to receive a content signal including a content image from a server,
process the content image and a first image to be displayed on the display,
in response to a size of the first image to be displayed not corresponding to a sensible size, resize the first image to obtain a second image of which a size is corresponding to the sensible size, and
control the display to display the content image and the obtained second image.

2. The display apparatus according to claim 1, further comprising an image sensor configured to sense the second image,
wherein when the size of the second image corresponds to the sensible size, the image sensor is able to provide information for identifying the content image via the sensed second image.

3. The display apparatus according to claim 2, wherein in response to the information for identifying the content image not being received from the image sensor, the processor determines that the first image is not corresponding to the sensible size.

4. The display apparatus according to claim 2, wherein the image sensor outputs recognition result of a preset color pattern included in sensed second image, and
wherein the processor identifies the content image based on the recognition result output from the image sensor.

5. The display apparatus according to claim 1, wherein the content image received from the server comprises the first image.

6. The display apparatus according to claim 1, wherein the processor is further configured to control the communication interface to individually receive the content image and the first image from the server.

7. The display apparatus according to claim 1, wherein the processor is further configured to generate the second image by downscaling the first image to the sensible size in response to the size of the first image being larger than the sensible size.

8. The display apparatus according to claim 7, wherein the processor is further configured to perform an image process to cease display of the first image in response to the size of the first image not corresponding to the sensible size.

9. The display apparatus according to claim 2, wherein a sensing area of the display is monitored by the image sensor, and
wherein the processor is further configured to provide a user interface (UI) for guiding adjustment of the sensing area in response to the first image not corresponding to the sensing area.

10. The display apparatus according to claim 2, further comprising a storage configured to store a plurality of images respectively corresponding to a plurality of content images,
wherein a sensing area of the display is monitored by the image sensor, and
wherein the processor is further configured to determine whether a corresponding content image of the plurality of content images is normally reproduced based on whether the image sensor sensing a corresponding one of the plurality of images in the sensing area.

11. The display apparatus according to claim 2, wherein a sensing area of the display is monitored by the image sensor, and
wherein the processor is further configured to perform optical character recognition (OCR) on the sensed second image and control the communication interface to transmit a result of the OCR to the server.

12. A method of controlling a display apparatus, the method comprising:
receiving a content signal including a content image from a server;
processing the content image and a first image to be displayed on a display;
in response to a size of the first image to be displayed not corresponding to a sensible size, resizing the first image to obtain a second image of which a size is corresponding to the sensible size, and
displaying the content image and the obtained second image.

13. The method according to claim 12, wherein the display apparatus comprises an image sensor configured to sense the second image, and
wherein when the size of the second image is corresponding to the sensible size, the image sensor is able to provide information for identifying the content image via the sensed second image.

14. The method according to claim 13, further comprises, in response to the information for identifying the content image not being received from the image sensor, determining that the first image does not correspond to the sensible size.

15. The method according to claim 13, wherein the image sensor outputs recognition result of a preset color pattern included in sensed second image, and
wherein the method further comprises identifying the content image based on the recognition result output from the image sensor.

16. The method according to claim 12, wherein the content image received from the server comprises the first image.

17. The method according to claim 12, further comprising receiving the first image from the server separate from the content image.

18. The method according to claim 12, wherein the resizing the first image comprises downscaling the first image to the sensible size in response to the size of the first image being larger than the sensible size.

19. The method according to claim 18, further comprising ceasing display of the first image in response to the size of the first image not corresponding to the sensible size.

20. The method according to claim 13, further comprising:
monitoring a sensing area of a display by the image sensor, and
providing a user interface (UI) for guiding adjustment of the sensing area in response to the first image not corresponding to the sensing area.

21. The method according to claim 13, further comprising:
storing a plurality of images respectively corresponding to a plurality of content images,
sensing the second image by the image sensor, and
determining whether the content image is normally reproduced based on whether the sensed second image corresponds to one of the plurality of images.

22. The method according to claim 13, further comprising:
sensing the second image displayed on the display by the image sensor;
receiving the sensed second image;
performing optical character recognition (OCR) on the received second image; and
transmitting a result of the OCR to the server.

23. A non-transitory computer readable recording medium having embodied thereon a program, which when executed by a processor of a display apparatus causes the display apparatus to execute a method, the method including:
receiving a content signal including a content image from a server;
processing the content image and a first image to be displayed on a display;
in response to a size of the first image to be displayed not corresponding to a sensible size, resizing the first image to obtain a second image of which a size is corresponding to the sensible size, and
displaying the content image and the obtained second image.
